(19) United States
(12) Patent Application Publication
(10) Pub. No.: US 2026/0024017 A1
(43) Pub. Date: Jan. 22, 2026

(54) NON-TRANSITORY COMPUTER-READABLE RECORDING MEDIUM, MACHINE LEARNING DEVICE, AND INFORMATION PROCESSING SYSTEM

(71) Applicant: Fujitsu Limited, Kawasaki-shi (JP)

(72) Inventor: Shunichi WATANABE, Kawasaki (JP)

(73) Assignee: Fujitsu Limited, Kawasaki-shi (JP)

(21) Appl. No.: 19/228,871

(22) Filed: Jun. 5, 2025

(30) Foreign Application Priority Data
Jul. 17, 2024 (JP) 2024-114240

(51) Int. Cl. G06N 20/00

(52) U.S. Cl. CPC G06N 20/00

(57) ABSTRACT

A process of collecting inference results that are obtained by inputting operation data to a trained machine learning model that has been trained based on training data, a process of generating clusters by performing density-based clustering on the collected inference results, a process of estimating, for each of the clusters, estimation labels associated with the corresponding clusters from among correct answer labels that correspond to all correct answers that can potentially be the inference results, and a process of performing fine-tuning on the trained machine learning model based on the pieces of operation data that belong to the corresponding clusters and based on the estimation labels associated with the corresponding clusters are performed.

### CROSS-REFERENCE TO RELATED APPLICATION

This application is based upon and claims the benefit of priority of the prior Japanese Patent Application No. 2024-114240, filed on Jul. 17, 2024, the entire contents of which are incorporated herein by reference.

### FIELD

The embodiment discussed herein is related to a computer-readable recording medium, a machine learning device, and an information processing system.

### BACKGROUND

Business operations using machine learning are performed in the following procedure. A trained machine learning model that is used by the business is generated by causing a machine learning model that has not been trained to repeatedly perform machine learning by using training data. The training data is also referred to as teacher data. By inputting operation data to the generated trained machine learning model, a forecast result that is requested in the business is output from the machine learning model.

However, an external environment is changed over time in the course of continuously using the machine learning model in the business, a trend of the operation data that is input to the machine learning model is sometimes changed to a trend that is different from the trend of the training data that has been used to train the machine learning model. As a result of this, a problem that degradation of inference accuracy of the machine learning model occurs caused by a difference between the training data that is used at the time of development of the machine learning model and the operation data, a variation in statistical trend of the input operation data, or the like occurs. Accordingly, developments of a technology for coping with such degradation in the inference accuracy of the machine learning model have been facilitated.

For example, there is a proposed technology for attempting an automatic accuracy recovery of the machine learning model in accordance with the operation data that has been input at the time of the operation. In this technology, the automatic accuracy recovery is attempted in a procedure described below. The operation data that has been input at the time of the operation is represented in a data space. The operation data represented in the data space is separated by a boundary line that is referred to as a decision boundary on the basis of the machine learning model. Then, the operation data represented in the data space is represented in a feature value space that is a mathematical space in which the characteristic of a data distribution is represented as a data group. The data group formed by the operation data in the feature value space is identified as a shape, and a change in the shape is tracked. Then, labeling is performed as a pseudo label with respect to the operation data that is represented in the data space as a classification result of the operation data indicated in the feature value space. After that, the automatic accuracy recovery of the machine learning model is performed by training the machine learning model again by using the operation data that has been subjected to the labeling. The pseudo label is, for example, a correct answer label that is given to the data that has not been subjected to the labeling on the basis of an estimation.

In an automatic recovery technique using the feature value space described above, for example, weights other than a BN (Batch Normalization) layer and a Fully Connected (FC) layer are fixed, and the BN layer and the FC layer are sequentially tuned. At this time, the tuning is performed by minimizing entropy on the basis of a Loss function that is a loss function. By performing retraining before each of the clusters exceeds the decision boundary caused by data tracking, it is guaranteed that the shape of the data group indicated in the feature value space is deformed as much as possible. Then, as a result of the shape of the data group indicated in the feature value space being guaranteed, the inference accuracy of the machine learning model is maintained.

Furthermore, the following technology is present as a technology for updating a machine learning model. For example, there is a proposed technology for causing the machine learning model to perform learning by clustering output data on the basis of similarities and associating the output data with a tag on the basis of one or more of the distance measure based on a spherical surface distance between images and the distance measure based on a spherical surface distance with likelihood of the maximum posterior probability or the center of gravity.

Furthermore, there is a proposed technology for updating an already existing AI model by determining a target parameter on the basis of a difference of a data distribution between an inference data set and a training data set, and obtaining labeled data suitable for a current inference data distribution from already existing labeled data in accordance with the parameter. Furthermore, there is a proposed technology for updating a machine learning model by using dynamically updated training data in a case where an important movement has been detected by using a histogram.
Patent Document 1: Japanese Laid-open Patent Publication No. 2019-125340
Patent Document 2: Japanese National Publication of International Patent Application No. 2023-535227
Patent Document 3: U.S. Patent Application Publication No. 2021/0390455

### SUMMARY

According to an aspect of an embodiment, a non-transitory computer-readable recording medium stores therein a machine learning program that causes a computer to execute a process including collecting inference results that are obtained from operation data based on a trained machine learning model that has been trained by using training data, generating clusters by performing density-based clustering on the collected inference results, estimating, for each of the clusters, estimation labels associated with the corresponding clusters from among correct answer labels that correspond to all correct answers that can potentially be the inference results, and performing fine-tuning on the trained machine learning model based on the pieces of operation data that belong to the corresponding clusters and based on the estimation labels associated with the corresponding clusters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a machine learning device according to an embodiment;

FIG. 2 is a diagram illustrating the outline of recovery learning and additional learning performed on a machine learning model;

FIG. 3 is a diagram illustrating one example of a result of density-based clustering;

FIG. 4 is a diagram for explaining density-based clustering;

FIG. 5 is a flowchart illustrating the flow of a learning process performed by the machine learning device according to the embodiment; and

FIG. 6 is a diagram illustrating a hardware configuration of the machine learning device.

### DESCRIPTION OF EMBODIMENT

However, in the automatic recovery technique using the feature value space, in some cases, the labeling with respect to the operation data is not appropriately performed, and, in a case where leaning is performed on the basis of entropy minimization, there may be a case in which additional learning is not always performed on each of the pieces of operation data in a direction of the correct answer.

Furthermore, in the technology for causing the machine learning model to perform learning by clustering the output data on the basis of the information related to the spherical surface distance between images, and associating the output data with the tag, a change in data caused by a lapse of time is not considered. Furthermore, in the technology for updating the AI model by using the labeled data obtained from the parameter on the basis of the difference of the data distribution between the inference data set and the training data set, the difference between the inference data and the training data is used, but a change in data caused by a lapse of time thereof is not considered. In addition, in also the technology for updating the machine learning model in a case where the important movement has been detected by using the histogram, a change in the data caused by a lapse of time is not considered. Consequently, it is difficult to appropriately adjust the width of the data tracking in accordance with the change in data.

Preferred embodiments will be explained with reference to accompanying drawings. Furthermore, the machine learning program, the machine learning device, and the information processing system disclosed in the present application are not limited to the embodiments.

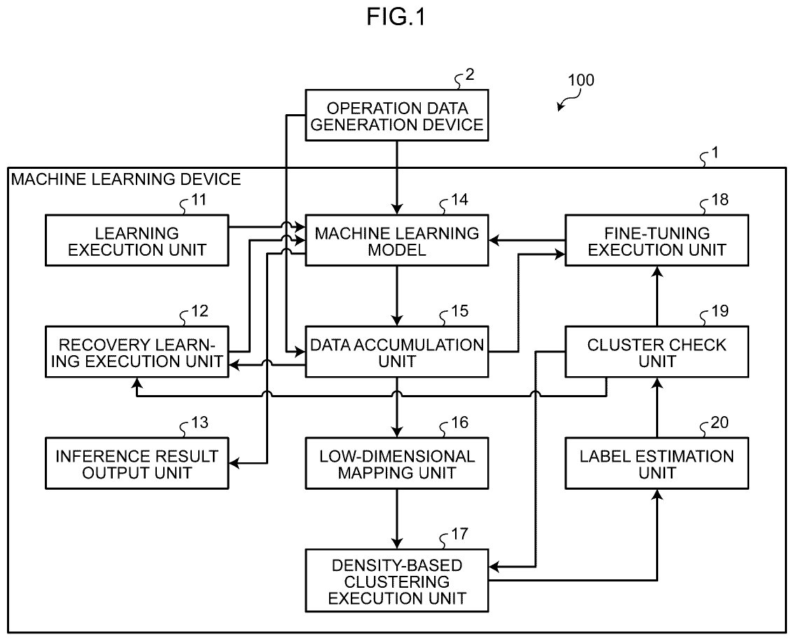

FIG. 1 is a block diagram of a machine learning device according to the embodiment. In an information processing system 100 according to the present embodiment, a machine learning device 1 is connected to an operation data generation device 2.

The operation data generation device 2 generates operation data that is used for an inference by the machine learning device 1, and provides the generated operation data to the machine learning device 1. The operation data mentioned here is data that is used by a system operation for performing business, and is data in which a correct answer for an inference is unknown. A large amount of operation data is present, and the operation data forms a data set.

For example, the operation data generation device 2 generates, as the operation data, images or the like of a large number of products manufactured in an operating factory captured by a camera. By using the images, the operation data generation device 2 is able to determine the quality of the products manufactured in the factory. Then, the operation data generation device 2 transmits the generated operation data to the machine learning device 1.

The machine learning device 1 receives an input of the operation data from the operation data generation device 2. Then, the machine learning device 1 performs an inference by using the input operation data. For example, in a case where an image of the product manufactured in the factory has been acquired as the operation data, the machine learning device 1 is able to perform an inference on the quality of the product captured in the image.

As illustrated in FIG. 1, the machine learning device 1 includes a learning execution unit 11, a recovery learning execution unit 12, an inference result output unit 13, a machine learning model 14, and a data accumulation unit 15. Furthermore, the machine learning device 1 includes a low-dimensional mapping unit 16, a density-based clustering execution unit 17, a fine-tuning execution unit 18, a cluster check unit 19, and a label estimation unit 20.

The learning execution unit 11 causes the machine learning model 14 to perform machine learning by using training data, and generates the machine learning model 14 that has been trained. The training data is teacher data that includes, for example, the input data and a correct answer of an inference with respect to the input data. A large amount of operation data is present, and the operation data forms a data set. For example, the learning execution unit 11 causes the machine learning model 14 to perform learning so as to infer, by using the teacher data that includes both of the images of the products manufactured in the factory and the information on the quality of the products, the quality of the products on the basis of the images of the products manufactured in the factory.

The machine learning model 14 is a model obtained by using, for example, a deep neural network (DNN). The machine learning model 14 is artificial intelligence (AI) that performs a predetermined inference on the basis of input operation data in response to an input of the operation data that has been generated by the operation data generation device 2. For example, the machine learning model 14 infers the quality of a product on the basis of an image in response to an input of the image of the product manufactured in the factory as the operation data.

The inference result output unit 13 acquires an inference result that is related to the operation data and that has been obtained from the machine learning model 14. Then, the inference result output unit 13 outputs the acquired inference result. For example, the inference result output unit 13 may also display the inference result on a display device, such as a monitor (not illustrated), or may also transmit the inference result to a terminal device used by a user who uses the inference result.

Here, it is conceivable that the data quality of the operation data may be changed as a result of the operation data being affected at the time of generation of the operation data due to a change in environment in which the operation data is generated, or the like. For example, as a result of accumulation of a stain on a lens of the camera that captures the product, a change, such as the image generated by the operation data generation device 2 becoming darker, occurs in the operation data. If this type of change occurs in the operation data in this way, it is conceivable that each of the training data that has been used by the machine learning model 14 for the learning and the operation data has a different trend.

In a case where each of the training data and the operation data has a different trend, the machine learning model 14 that has been trained by using the training data may possibly be unable to perform an appropriate inference in a case where the changed operation data is used. For example, in a case where the machine learning model 14 performs an inference by using an input of an image of a product that is supposed to be evaluated to have good quality under ordinary circumstances, it is conceivable that the machine learning model 14 may possibly determine that the product is a defective product due to a change in operation data. As described above, it is conceivable that the inference accuracy of the machine learning model 14 is degraded over time.

The data accumulation unit 15 acquires the operation data that has been input from the operation data generation device 2, and accumulates the pieces of acquired operation data. Furthermore, the data accumulation unit 15 acquires the inference results obtained from the machine learning model 14, accumulates the inference results in an associated manner with the pieces of corresponding operation data. The data accumulation unit 15 also acquires the operation data and the inference result obtained in a case where an inference has been performed by the machine learning model 14 in which tuning has been performed by the recovery learning execution unit 12, and accumulates the pieces of acquired operation data and the inference results in an associated manner.

As described above, the data accumulation unit 15 collects, on the basis of the trained machine learning model 14 that has been trained by using the training data, the inference results obtained from the pieces of operation data. Furthermore, the data accumulation unit 15 collects the inference results that are obtained by inputting the operation data to the machine learning model 14 in which tuning has been performed by the recovery learning execution unit 12.

In a case where degradation of the inference accuracy occurs in the machine learning model 14 caused by a change in the operation data as described above, the recovery learning execution unit 12 causes the machine learning model 14 to perform recovery learning by using the operation data held at that time, and recovers the inference accuracy. For example, the recovery learning execution unit 12 represents the operation data by using points located on the coordinates, and separates the points by using a boundary line for each label. Then, the recovery learning execution unit 12 continuously tracks a change in distribution of the operation data. The recovery learning execution unit 12 fixes, on the basis of the tracking result, weights of operation data located other than the BN layer and the FC layer, and performs tuning on the BN layer and the FC layer such that the entropy is minimized on the basis of a Loss function, whereby the recovery learning execution unit 12 automatically adjusts the machine learning model 14 and recovers the inference accuracy. The tuning performed by the recovery learning execution unit 12 is referred to as recovery learning, and the machine learning model 14 in which the recovery learning has been performed is referred to as the adjusted machine learning model 14.

Here, the Loss function corresponds to one example of a “predetermined loss function”. The recovery learning execution unit 12 acquires both of the inference results that are obtained by inputting the operation data to the trained machine learning model 14 and the tracking labels that are obtained from among the correct answer labels by tracking the change in the operation data. Then, the recovery learning execution unit 12 causes the trained machine learning model 14 to perform learning such that the entropy indicated in the predetermined loss function is minimized on the basis of both of the inference result and the tracking label, and generates the machine learning model 14 that has been adjusted.

Here, in a case where the recovery learning is performed, the operation data also includes data that is difficult for a label to be allocated or the operation data to which a label that is different from the label of the correct answer is allocated is present. As a result of this, by performing the recovery learning by using the operation data obtained by performing incorrect labeling, there may be a case in which learning is performed in the incorrect direction caused by the entropy minimization. Accordingly, the machine learning device 1 improves the inference accuracy by performing additional learning described below.

The low-dimensional mapping unit 16 acquires the inference results obtained from the adjusted machine learning model 14 from the data accumulation unit 15. Then, the low-dimensional mapping unit 16 maps the inference results each having the number of dimensions corresponding to the number of classes that is the number of different labels assigned to the operation data into a lower dimension. In the present embodiment, the low-dimensional mapping unit 16 maps the inference result into the two dimensions. As described above, the low-dimensional mapping unit 16 maps the data that is related to the inference result and that has the number of dimensions corresponding to the number of correct answer labels into the lower dimension.

The density-based clustering execution unit 17 acquires the inference results that have been mapped into the two dimensions by the low-dimensional mapping unit 16. Then, the density-based clustering execution unit 17 performs density-based clustering, in which the number of clusters agrees with the number of classes, on the inference results that have been mapped into the two dimensions.

The density-based clustering is a technique for forming, from the data set, each of the clusters related to a data group that has a high density. For example, the density-based clustering execution unit 17 performs the density-based clustering on an image by using the data group located in a predetermined distance from the center corresponding to the point of the highest density in each of the data group as a cluster. In the density-based clustering, it is possible to detect an outlier and noise, and it is possible to treat an outlier as data that is not included in any cluster. As a result of removing the outlier and noise from the data constituting the clusters, the density-based clustering execution unit 17 is able to generate the clusters constituted by the data groups associated with the corresponding labels with high accuracy.

The density-based clustering execution unit 17 is able to classify the inference results that have been mapped into the two dimensions into the clusters having number corresponding to the number of classes by performing the above described density-based clustering. The density-based clustering execution unit 17 outputs the result of the clustering to the label estimation unit 20.

After that, when the density-based clustering execution unit 17 receives an instruction to re-perform the clustering from the cluster check unit 19, the density-based clustering execution unit 17 adjusts the parameter, such as the distance from the point of the highest density in a case where a cluster is generated, for the density-based clustering. After that, the density-based clustering execution unit 17 re-performs the density-based clustering in which the parameter has been adjusted, and outputs the result of the re-performed clustering to the label estimation unit 20.

As described above, the density-based clustering execution unit 17 performs the density-based clustering on the mapped inference result. Furthermore, the density-based clustering execution unit 17 performs the density-based clustering such that the number of clusters agrees with the number of correct answer labels.

The label estimation unit 20 receives, from the density-based clustering execution unit 17, an input of the results of the clustering of the inference results mapped into the two dimensions. Then, the label estimation unit 20 estimates, by using the label attached to each of the classes and the inference results obtained from the machine learning model 14, a label supported by each of the clusters. Then, the label estimation unit 20 outputs the information on the estimation label with respect to each of the cluster to the cluster check unit 19. As described above, the label estimation unit 20 estimates, for each cluster, the estimation labels associated with the corresponding clusters from among the correct answer labels that correspond to all of the correct answers that can potentially be the inference results.

The cluster check unit 19 receives, from the label estimation unit 20, an input of the information on the estimation label with respect to each of the clusters. Then, the cluster check unit 19 determines whether or not the number of different estimation labels agrees with the number of clusters. In other words, the cluster check unit 19 determines whether or not the estimation labels are associated with the corresponding correct answer labels on a one-to-one basis. In a case where the number of estimation labels is less than the number of clusters and the number of different estimation labels does not agree with the number of clusters, the cluster check unit 19 determines whether the density-based clustering has been re-performed.

If the density-based clustering is not re-performed, the cluster check unit 19 instructs the density-based clustering execution unit 17 to re-perform clustering. In contrast, if the density-based clustering has been re-performed, the cluster check unit 19 instructs the recovery learning execution unit 12 to increase the operation data and re-perform the recovery learning.

On the other hand, if the number of different estimation labels agrees with the number of clusters, the cluster check unit 19 outputs the information on the estimation label with respect to each of the clusters to the fine-tuning execution unit 18.

The fine-tuning execution unit 18 receives an input of the information on the estimation label with respect to each of the clusters from the cluster check unit 19. Then, the fine-tuning execution unit 18 acquires the operation data that belongs to each of the clusters from the data accumulation unit 15. Then, the fine-tuning execution unit 18 generates pair data constituted by the operation data and the estimation label in combination.

After that, the fine-tuning execution unit 18 causes the adjusted machine learning model 14 to perform the additional learning by using pair data. By causing the adjusted machine learning model 14 to perform the additional learning, the fine-tuning execution unit 18 is able to improve the inference accuracy of the adjusted machine learning model 14. As described above, the fine-tuning execution unit 18 performs fine-tuning on the trained machine learning model 14 on the basis of the pieces of operation data that belong to the corresponding clusters and on the basis of the estimation labels that are associated with the corresponding clusters. Furthermore, in a case where the number of clusters agrees with the number of correct answer labels, and also, the estimation labels are associated with the corresponding correct answer labels in the class on a one-to-one basis, the fine-tuning execution unit 18 performs the fine-tuning.

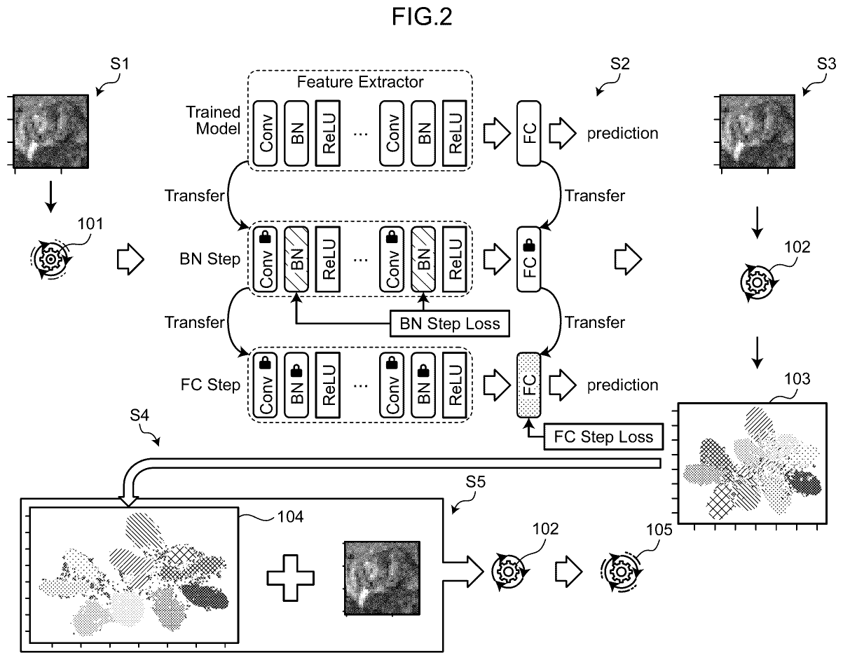

FIG. 2 is a diagram illustrating the outline of each of the recovery learning and the additional learning performed in the machine learning model. In the following, the outline of each of the recovery learning and the additional learning performed in the machine learning model 14 will collectively be described with reference to FIG. 2. Here, the trained machine learning model 14 that has been trained by the learning execution unit 11 is referred as a machine learning model 101.

The machine learning model 101 performs an inference on the operation data that has been input while the machine learning device 1 is in operation, and outputs an inference result (Step S1). The operation data is changed over time, and thus, the inference accuracy of the machine learning model 101 is degraded.

Accordingly, the recovery learning execution unit 12 fixes the weights of the operation data other than the BN layer and the FC layer on the basis of the tracking results obtained by continuously tracking a change in distribution of the operation data, and performs tuning on the BN layer and the FC layer such that the entropy is minimized on the basis of a Loss function. As a result of this, the recovery learning execution unit 12 automatically adjusts the machine learning model 101, and generates a machine learning model 102 in which the inference accuracy has been recovered (Step S2).

Then, the machine learning model 102 performs an inference in response to an input of the operation data, and outputs the inference result with respect to the input operation data. The data accumulation unit 15 collects and accumulates the inference results with respect to a large amount of operation data obtained from the machine learning model 102 together with the operation data. Then, the low-dimensional mapping unit 16 acquires the inference results from the data accumulation unit 15, and acquires a mapping result 103 by mapping the inference result into a lower dimension (Step S3). The mapping result 103 represents a class of the inference results of different data groups in each of which the added pattern is different.

The density-based clustering execution unit 17 performs density-based clustering such that the number of inferred classes agrees with the number of inferred clusters with respect to the mapping result 103 (Step S4). Furthermore, the label estimation unit 20 estimates a label of each of the clusters.

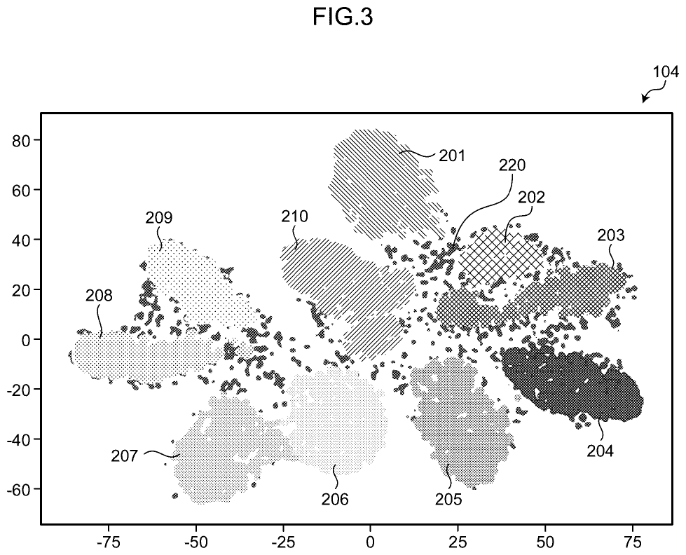

FIG. 3 is a diagram illustrating one example of a result of the density-based clustering. For example, the density-based clustering execution unit 17 performs the density-based clustering on the mapping result 103, and classifies the data of the inference results into clusters 201 to 210. Here, data 220 represents data on outliers and noise. The density-based clustering execution unit 17 removes the data 220 corresponding to the outlier and noise, and performs clustering.

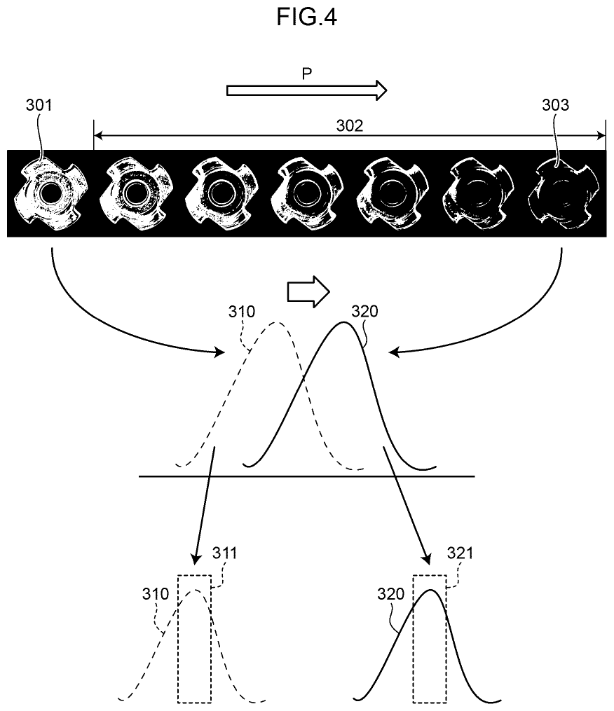

FIG. 4 is a diagram illustrating the density-based clustering. Here, a description will be given in a case where, for example, an image of a product is used as the operation data. An image 301 is training data, and the data included in a region 302 is the operation data. An arrow P indicates that time has elapsed in the direction of the arrow P, and the operation data is changed caused by data drift that has occurred over time. As a result of the change in the operation data over time, both of the image 301 and an image 303 are good quality images, but have different data quality.

Here, a data distribution 310 indicates a distribution of the inference results with respect to the training data. Furthermore, a data distribution 320 indicates a distribution of the inference results at the time of generation of the image 303. As indicated by the data distribution 310 and the data distribution 320, the inference results are shifted, but the distribution shapes are substantially the same, and a high density portion in the data distribution 310 corresponds to a high density portion in the data distribution 320. Then, it is conceivable that a data group 311 included in the high density portion in the data distribution 310 seems to be reliable, and also, a data group 321 in the high density portion in the data distribution 320 seems to be reliable. In other words, the label of the data group 321 is highly likely to agree with the label of the data group 311. In the density-based clustering, the data group 321 included in the data distribution 320 is grouped as a cluster. In other words, it can be said that the density-based clustering is able to perform clustering that appropriately responds to the label.

For example, in a case where k-means clustering is used, the clustering is performed such that all of the pieces of data are included in any one of the clusters. Furthermore, in the k-means clustering, a density of the data distribution is not considered. On the other hand, the density-based clustering execution unit 17 is able to perform clustering that further appropriately responds to the label by performing the density-based clustering such that the data corresponding to the outlier and noise are excluded. As a result of this, the label estimation unit 20 is able to estimate the label with high accuracy.

A description will be given here by referring back to FIG. 2. The fine-tuning execution unit 18 generates the pair data of the estimation label obtained by the label estimation unit 20 and the operation data. Then, the fine-tuning execution unit 18 causes the machine learning model 14 to perform additional learning by using the pair data (Step S5). As a result of this, the fine-tuning execution unit 18 is able to generate a machine learning model 105 in which the inference accuracy has been recovered.

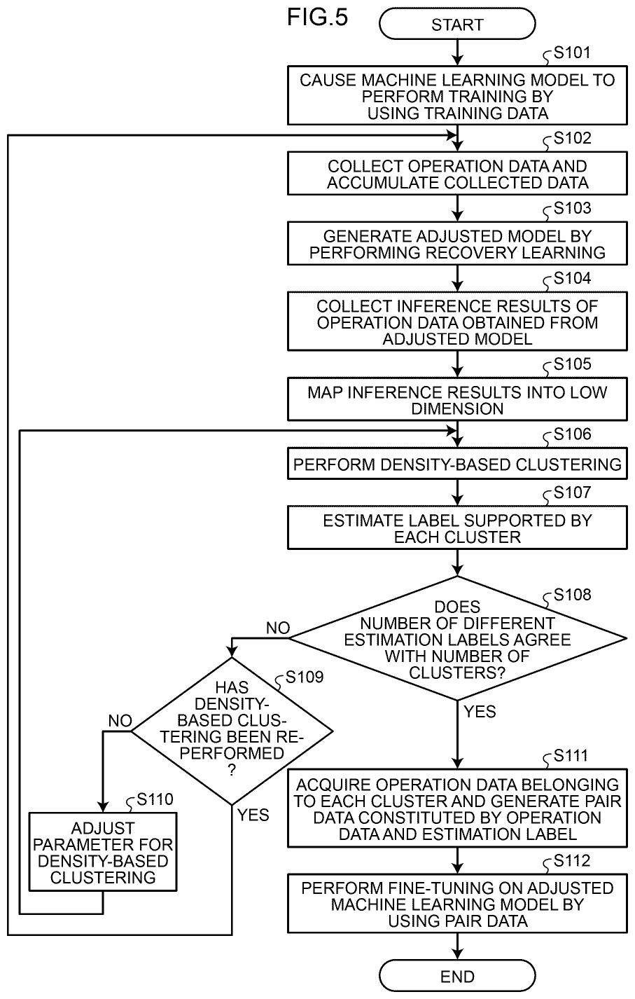

FIG. 5 is a flowchart of the learning process performed by the machine learning device according to the embodiment. In the following, the flow of the learning process performed by the machine learning device 1 according to the embodiment will be described with reference to FIG. 5.

The learning execution unit 11 causes the machine learning model 14 to perform the machine learning by using the training data, and generates the trained machine learning model 14 (Step S101).

The data accumulation unit 15 acquires the operation data that has been input from the operation data generation device 2. Furthermore, the data accumulation unit 15 acquires the inference result obtained from the machine learning model 14. Then, the data accumulation unit 15 accumulates the operation data and the inference result in an associated manner (Step S102).

The recovery learning execution unit 12 fixes the weights other than the BN layer and the fully connected layer on the basis of the tracking results obtained by continuously tracking a change in distribution of the operation data, and performs tuning on the BN layer and the fully connected layer such that the entropy is minimized on the basis of a Loss function. As a result of this, the recovery learning execution unit 12 automatically adjusts the machine learning model 101, and generates the adjusted machine learning model 14 (Step S103).

The data accumulation unit 15 collects operation data and the inference results that are obtained from the adjusted machine learning model 14 by inputting the operation data, and accumulates the collected operation data and the inference results in an associated manner (Step S104).

The low-dimensional mapping unit 16 acquires, from the data accumulation unit 15, the inference results obtained from the adjusted machine learning model 14. Then, the low-dimensional mapping unit 16 maps the inference results having the number of dimensions corresponding to the number of classes into a lower dimension (Step S105).

The density-based clustering execution unit 17 performs the density-based clustering such that the number of clusters agrees with the number of classes on the inference results that have been mapped into the two dimensions (Step S106).

The label estimation unit 20 estimates a label, by using the label attached to each of the classes and the inference results obtained from the machine learning model 14, a label supported by each of the clusters (Step S107).

The cluster check unit 19 determines whether or not the number of different estimation labels agrees with the number of clusters (Step S108).

If the number of different estimation labels does not agree with the number of clusters (No at Step S108), the cluster check unit 19 determines whether or not the density-based clustering has been re-performed (Step S109).

If the density-based clustering has not been re-performed (No at Step S109), the cluster check unit 19 instructs the density-based clustering execution unit 17 to re-perform the clustering. The density-based clustering execution unit 17 adjusts the parameter for the density-based clustering (Step S110). After that, the learning process returns to the process at Step S106.

On the other hand, if the density-based clustering has been re-performed (Yes at Step S109), the cluster check unit 19 instructs the low-dimensional mapping unit 16 to start the process after having increased the operation data. Then, the learning process returns to the process at Step S102.

In contrast, if the number of different estimation labels agrees with the number of clusters (Yes at Step S108), the cluster check unit 19 outputs the information on the estimation label with respect to each of the clusters to the fine-tuning execution unit 18. The fine-tuning execution unit 18 acquires the pieces of operation data that belong to the corresponding clusters from the data accumulation unit 15. Then, the fine-tuning execution unit 18 generates the pair data constituted by the operation data and the estimation label in combination (Step S111).

After that, the fine-tuning execution unit 18 performs the fine-tuning by causing the adjusted machine learning model 14 to perform the additional learning by using the pair data (Step S112).

Here, in the explanation described above, the machine learning device 1 performs the additional learning after having performed the clustering such that the number of clusters is associated with the labels of the inference results on a one-to-one basis, but the embodiment is not limited to this. Even in a case where the number of clusters generated by the clustering is not associated with the labels on a one-to-one basis, the machine learning device 1 may estimate a label of the subject cluster and may cause the adjusted machine learning model 14 to perform the additional learning by using both of the pieces of operation data that belong the corresponding clusters and the estimation labels. For example, even in a case where the cluster is associated with some of the labels, the machine learning device 1 is able to improve the inference accuracy by causing the adjusted machine learning model 14 to perform learning by using the subject cluster.

Furthermore, in the explanation described above, the machine learning device 1 performs fine-tuning on the adjusted machine learning model 14 that is obtained by causing the machine learning model 14 to perform the recovery learning by using the data that has been labeled by tracking a change in the operation data, but the embodiment is not limited to this. The machine learning device 1 is able to perform the fine-tuning by using the density-based clustering described above on the machine learning model 14 as long as the machine learning model 14 performs an inference by using the data that is changed over time and that can be classified to some extent.

As explained above, the machine learning device 1 fixes the weights other than the BN layer and the fully connected layer on the basis of the tracking result obtained by continuously tracking a change in distribution of the operation data, performs the tuning by minimizing the entropy on the basis of a Loss function, and generates the adjusted machine learning model 14. Furthermore, the machine learning device 1 maps the inference results that are obtained by inputting the operation data to the adjusted machine learning model 14 into a lower dimension, and performs the density-based clustering on the mapped inference results. Then, the machine learning device 1 estimates a label of the cluster, and causes the adjusted machine learning model 14 to perform the additional learning by using both of the pieces of operation data that belong to the cluster and the estimation label.

As a result of this, even in a case where the operation data has been uniformly changed due to data drift, the machine learning device 1 is able to alleviate a reduction in the inference accuracy of the machine learning model 14. In other words, the machine learning device 1 is able to improve robustness of the machine learning model 14 with respect to the data drift. As described above, even in a case where a label that indicates a correct answer for an inference with respect to the operation data is not present, it is possible to perform a stable AI operation.

For example, a comparative study of the inference accuracy is conducted in a case in which, for example, CIFAR-10 is used as the training data, and a destruction ratio of the operation data to the training data is set to the maximum. In this case, as compared with the trained machine learning model 14 or the adjusted machine learning model 14 that is obtained by using an internal parameter adjustment technology, the inference accuracy becomes high in the machine learning model 14 that has been subjected to the additional learning on the adjusted machine learning model 14. In other words, the machine learning device 1 improves robustness with respect to a change in the operation data as compared to the trained machine learning model and the adjusted machine learning model.

### Hardware Configuration

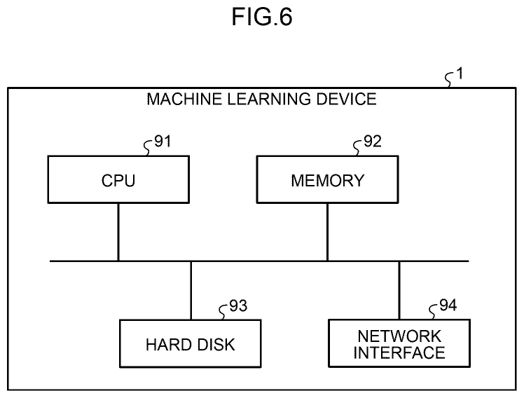

FIG. 6 is a diagram illustrating a hardware configuration of the machine learning device. In the following, one example of the hardware configuration for implementing each of the functions of the machine learning device 1 will be described with reference to FIG. 6.

As illustrated in FIG. 6, the machine learning device 1 includes, for example, a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the machine learning device 1 and an external device. The network interface 94 relays communication between, for example, the operation data generation device 2 and the CPU 91.

The hard disk 93 is an auxiliary storage device. The hard disk 93 stores therein the machine learning model 14 illustrated in FIG. 1 as an example. Furthermore, the hard disk 93 is also able to use an accumulation location for the data stored in the data accumulation unit 15. Furthermore, the hard disk 93 stores therein various kinds of programs including the program that will be described below. For example, the hard disk 93 stores therein the programs for implementing the function of the learning execution unit 11, the recovery learning execution unit 12, the inference result output unit 13, and the data accumulation unit 15 illustrated in FIG. 1 as an example. Furthermore, the hard disk 93 stores therein the programs for implementing the function of the low-dimensional mapping unit 16, the density-based clustering execution unit 17, the fine-tuning execution unit 18, the cluster check unit 19, and the label estimation unit 20 illustrated in FIG. 1 as an example.

The memory 92 is a main storage device. For example, a dynamic random access memory (DRAM) may be used for the memory 92.

The CPU 91 reads out the various kinds of programs from the hard disk 93, loads the read programs into the memory 92, and executes the programs. As a result of this, the CPU 91 implements the function of the learning execution unit 11, the recovery learning execution unit 12, the inference result output unit 13, and the data accumulation unit 15 illustrated in FIG. 1 as an example. Furthermore, the CPU 91 implements the functions of the low-dimensional mapping unit 16, the density-based clustering execution unit 17, the fine-tuning execution unit 18, the cluster check unit 19, and the label estimation unit 20 illustrated in FIG. 1 as an example.

According to an aspect of one embodiment, the present invention enables a stable AI operation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a machine learning program that causes a computer to execute a process comprising:
collecting inference results that are obtained from operation data based on a trained machine learning model that has been trained by using training data;
generating clusters by performing density-based clustering on the collected inference results;
estimating, for each of the clusters, estimation labels associated with the corresponding clusters from among correct answer labels that correspond to all correct answers that can potentially be the inference results; and
performing fine-tuning on the trained machine learning model based on the pieces of operation data that belong to the corresponding clusters and based on the estimation labels associated with the corresponding clusters.

2. The non-transitory computer-readable recording medium according to claim 1, wherein the process further includes
generating an adjusted machine learning model by causing the trained machine learning model to perform learning such that entropy indicated in a predetermined loss function is minimized based on the inference results obtained by inputting the operation data to the trained machine learning model and based on a tracking label obtained from among the correct answer labels by tracking a change in the operation data, wherein
the collecting includes collecting inference results that are obtained by inputting the operation data to the adjusted machine learning model.

3. The non-transitory computer-readable recording medium according to claim 1, wherein the generating includes
mapping data on the inference results having the number of dimensions corresponding to the number of the correct answer labels into a lower dimension, and
performing the density-based clustering on the mapped inference results.

4. The non-transitory computer-readable recording medium according to claim 1, wherein
the generating includes performing the density-based clustering such that the number of the clusters agrees with the number of the correct answer labels, wherein the process further includes:
determining whether or not the estimation labels are associated with the corresponding correct answer labels on a one-to-one basis, wherein
the fine-tuning is performed when the number of the clusters agrees with the number of the correct answer labels, and also, when the estimation labels are associated with the corresponding correct answer labels in a class on a one-to-one basis.

5. A machine learning device comprising:
a processor configured to:
collect inference results that are obtained by inputting operation data to a trained machine learning model that has been trained based on training data;
generate clusters by performing density-based clustering on the inference results that are collected;
estimate, for each of the clusters that have been generated, estimation labels associated with the corresponding clusters from among correct answer labels that correspond to all correct answers that can potentially be the inference results; and
perform fine-tuning on the trained machine learning model based on the pieces of operation data that belong to the corresponding clusters and based on the estimation labels associated with the corresponding clusters.

6. An information processing system comprising:
a machine learning device; and
an operation data generation device, wherein
the machine learning device includes
a processor configured to:
collect inference results that are obtained by inputting operation data obtained from the operation data generation device to a trained machine learning model that has been trained based on training data,
generate clusters by performing density-based clustering on the inference results that are collected,
estimate, for each of the clusters that have been generated, estimation labels associated with the corresponding clusters from among correct answer labels that correspond to all correct answers that can potentially be the inference results, and
perform fine-tuning on the trained machine learning model based on the pieces of operation data that belong to the corresponding clusters and based on the estimation labels associated with the corresponding clusters.
